(19) United States
(12) Patent Application Publication
(10) Pub. No.: US 2002/0176692 A1
(43) Pub. Date: Nov. 28, 2002

(54) System and method of synchronizing playback of video and user agent content in an optical disc player

(76) Inventors: Masato Otsuka, Torrance, CA (US); Ramaswamy Devarajan, Long Beach, CA (US); Sanjay Kulkarni, Torrance, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/978,759

(22) Filed: Oct. 15, 2001

Related U.S. Application Data
(60) Provisional application No. 60/324,611, filed on Sep. 24, 2001.
(60) Provisional application No. 60/293,395, filed on May 23, 2001.

(51) Int. Cl. H04N 5/781

(52) U.S. Cl. 386/95; 386/126

(57) ABSTRACT

A system and method of synchronizing user agent data with video data in an optical disc player. The optical disc player includes an optical disc reader to read a user agent document, a video segment, a different user agent document, and a second video segment from a local optical disc, a user agent module to control a display of the user agent document and the different user agent document, a video playback module to control a display of the video segment and the different video segment; and an interaction application which causes a display of the user agent document with the video segment, and subsequently causes a display of the different user agent document and/or the different video segment in response to an event being generated. The event can be generated by the video playback module, the user agent module, the interaction application, or by a device external to the optical disc player.

### CROSS-REFERENCE TO RELATED PATENT APPLICATIONS

This application claims the benefit of the respective filing dates of Provisional Patent Application Serial No. 60/324,611, filed on Sep. 24, 2001, and entitled “System and Method of Synchronizing Playback of Video and User Agent Content in an Optical Disc Player”, and Provisional Patent Application Serial No. 60/293,395, filed on May 23, 2001, and entitled “Method of Controlling Time-Based Events in Video Playback for Handling by User Agent Program in an Optical Disc Player”, both of which are incorporated herein by reference.

### FIELD OF THE INVENTION

This invention relates generally to optical disc players, such as digital versatile disc (DVD) players and other formats, that have user-agent program (e.g. browser) playback capability (including local as well as network (e.g. the Internet) access capability). In particular, the invention relates to a system and method of synchronizing playback of video and user agent content in an optical disc player.

### BACKGROUND OF THE INVENTION

The invention relates to optical disc players that can play user agent data and video data concurrently. The optical disc player operates a user agent program which can access user agent documents (e.g. HTML documents containing text, images, such as JPEG and GIF images, animated content, etc.) available from one or more external sources (e.g. a server across the Internet or Intranet, an external hard drive, and/or an external optical disc drive, etc.) and/or from the local optical disc. The optical disc player also operates a video playback module which can access and display video content from one or more external sources and/or the local optical disc.

Content developers may desire to author programs stored on a local optical disc for execution by an optical disc player that interacts user agent documents with video content. For example, a content developer may author an optical disc containing a video movie as well as user agent documents containing information about the movie. In this regard, the optical disc player under the control of the interaction application, user agent program and the video playback program loads one of the user agent documents associated with chapter one of the video movie and loads chapter one of the video movie in a sub-window. When the video movie chapter changes to chapter two, another user agent document is loaded that is synchronized with chapter two of the movie video.

Content developers, in developing applications that interact user agent documents with video segments, need to synchronize the displaying of the user agent documents with the displaying of the corresponding video segments. In the above example, synchronism of the user agent document with the video segment was based on the transitioning of a video chapter. However, there may be other events that require changing user agent documents and/or video segments. These events can arise from the playback of the video segment, from actions occurring in the user agent document, and from user intervention.

Thus, there is a need for a system and method of synchronizing playback of video and user agent document. Such a need and others are provided for with the system and method of synchronizing playback of video and user agent documents in accordance with the invention.

### SUMMARY OF THE INVENTION

An aspect of the invention relates to a method of synchronizing user agent data with video data in an optical disc player. The method comprises displaying a user agent document with a video segment and then displaying a different user agent document and/or a different video segment in response to an event being generated. The event may be generated by the video playback module of the optical disc player. If such is the case, the event may relate to the video title being changed, or the video chapter being changed, or a specified time elapsed of video playback occurring, or a user activating a video control button, or other event related to the video playback module. The event may also be generated by the user agent module of the optical disc player. If such is the case, the event may relate to the terminating of a flash routine on a user agent document, or a user activating a link within the user agent document, or other event related to the user agent module.

The event may also be generated by an interaction application authored by a content developer for controlling the synchronism between the user agent data and the video data. If such is the case, the event may relate to a sub-routine within the interaction application being executed, such as a timer sub-routine, an interrupt sub-routine, or other events related to the execution of the interaction application. The event may also be generated from sources external to the optical disc player, such as a server or computer connected to a local area network or wide area network, or an external device such as an external hard drive, an external optical disc, a printer, scanner, digital camera, etc. The event may also relate to property changes of any device or software module internal or external to the optical disc player.

In terms of an exemplary execution of the method of synchronizing user agent data with video data, information related to the event, such as an event identifier with possibly one or more parameters, are sent to the interaction application by way of a call back routine from the user agent module. Based on the event information provided to the interaction application, the interaction application executes an event handling routine which performs a video-user agent synchronization action. The name of the event handling routine can be fixed in the user agent module, such that when an event is generated, the user agent module always calls the same event handling routine. Alternatively, the name of the event handling routine can be dynamically assigned by the interaction application based on the event generated.

Another aspect of the invention relates to an optical disc player that implements the above methodology of the invention. The optical disc player comprises an optical disc reader to read a user agent document, a video segment, a different user agent document, and a different video segment from a local optical disc, a user agent module to control a display of the user agent document and the different user agent document, a video playback module to control a display of the video segment and the different video segment; and an interaction application which causes a display of the user agent document with the video segment, and subsequently causes a display of the different user agent document and/or the different video segment in response to an event being generated. The event can be generated by the video playback module, the user agent module, the interaction application, operating system, or by a device external to the optical disc player.

Other aspects, features and techniques of the invention will become apparent to one skilled in the relevant art in view of the following detailed description of the invention.

### BRIEF DESCRIPTION OF THE DRAWINGS

FIG. 1 illustrates a hardware block diagram of an exemplary optical disc player in accordance with the invention;

FIG. 2 illustrates a functional block diagram of an exemplary optical disc player in accordance with the invention;

FIG. 3A illustrates a flow diagram of an exemplary method of synchronizing video data with user agent data using an event generated by a video playback module in accordance with the invention;

FIG. 3B illustrates a flow diagram of an exemplary method of synchronizing video data with user agent data using periodic time-based events generated by a video playback module in accordance with the invention;

FIG. 3C illustrates a flow diagram of an exemplary method of synchronizing video data with user agent data using a set time-based event generated by a video playback module in accordance with the invention;

FIG. 4 illustrates a flow diagram of another exemplary method of synchronizing video data with user agent data using an event generated by a user agent module in accordance with the invention;

FIG. 5 illustrates a flow diagram of another exemplary method of synchronizing video data with user agent data using an event generated by an interaction application in accordance with the invention;

FIG. 6 illustrates a flow diagram of another exemplary method of synchronizing video data with user agent data using an event and/or property change generated by an internal and/or external source in accordance with the invention;

FIG. 7 illustrates a diagram illustrating the results of an exemplary video-user agent data synchronism in accordance the invention.

### DETAILED DESCRIPTION OF THE INVENTION

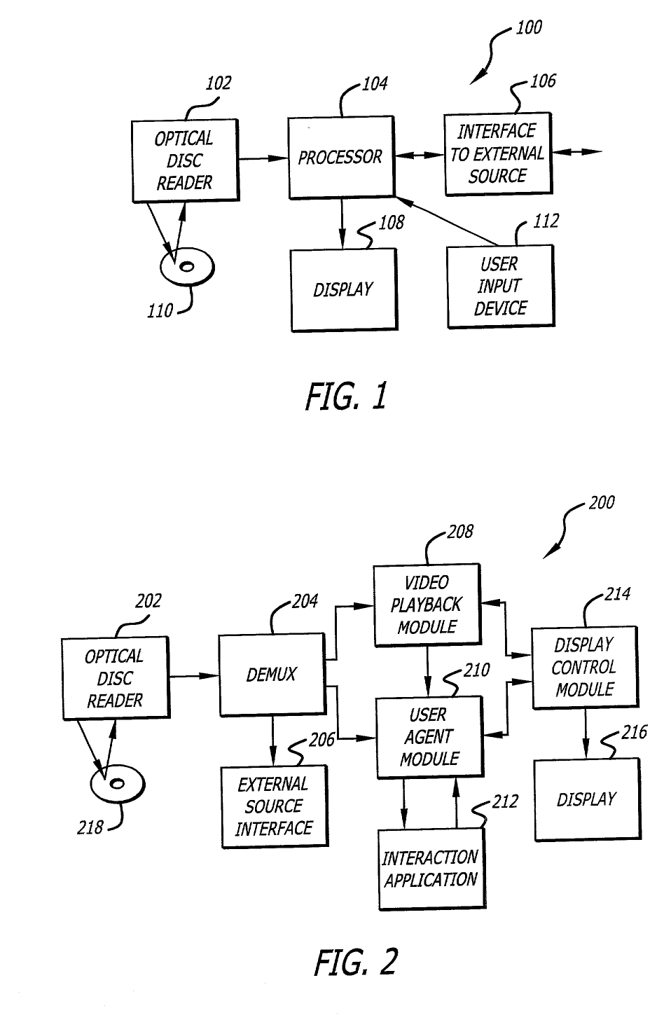

FIG. 1 illustrates a hardware block diagram of an exemplary optical disc player 100 in accordance with the invention. The optical disc player 100 comprises an optical disc reader 102, a processor 104, an interface to external sources 106, a display 108, and a user input device 112. The optical disc player 100 may be embodied as a dedicated optical disc player or as a program running on a computer. The processor 108 executes a user agent program which controls the accessing of video data and user agent data from a local optical disc 110 and external sources (a server on the Internet or intranet, an external hard drive, an external optical disc drive, etc.) respectively by way of the optical disc reader 102 and the external source interface 106. The processor 108 under the control of the user agent program and the video playback program also causes the display of user agent documents containing video on the display 108. The user input device 112 (e.g. keyboard, mouse, remote control, etc.) allows a user to navigate between different user agent documents and to change the video content being displayed.

FIG. 2 illustrates a functional block diagram of an exemplary optical disc player 200 in accordance with the invention. The optical disc player 200 comprises an optical disc reader 202, a buffer/demultiplexer 204, an external source interface 206 (e.g. a TCP/IP, HTTP, and/or USB interface), video playback module 208 (e.g. a DVD playback subsystem), a user agent module 210 (e.g. a browser program), an interaction application 212 (e.g. user agent document such as HTML document), a display control module 214, and optionally a display 216. User agent data and video data are stored on a local optical disc 218 which is read by the optical disc reader 202 and sent to the de-multiplexer 204. Also, there may be user agent data and video data at an external source (e.g. a server located across the Internet or intranet, an external hard drive or external optical drive, etc.) which may be sent to the buffer/demultiplexer 204 by way of the external source interface 206. The buffer/demultiplexer 204 separates the video data from the user agent data and sends them respectively to the video playback module 208 and the user agent module 210. The outputs of the video playback module 208 and the user agent module 210 are coupled to the display control 214 which delivers user agent documents with video data to the display 216 under the control of the interaction application 212.

According to the system and method of the invention, synchronization of video content with user agent documents is accomplished by monitoring and handling events that occur within or external to the optical disc player 100 (200). For instance, events can be generated by the video playback module 208, by the user agent module 210, the interaction application 212, by the user selecting a button from the user input device 112, or by external sources by way of the external source interface 206. Once the event has occurred, an event identifier is transmitted to an event handling routine in the interaction application 212. The event handling routine performs a specific operation typically specified by the content developer authoring the interaction application 212.

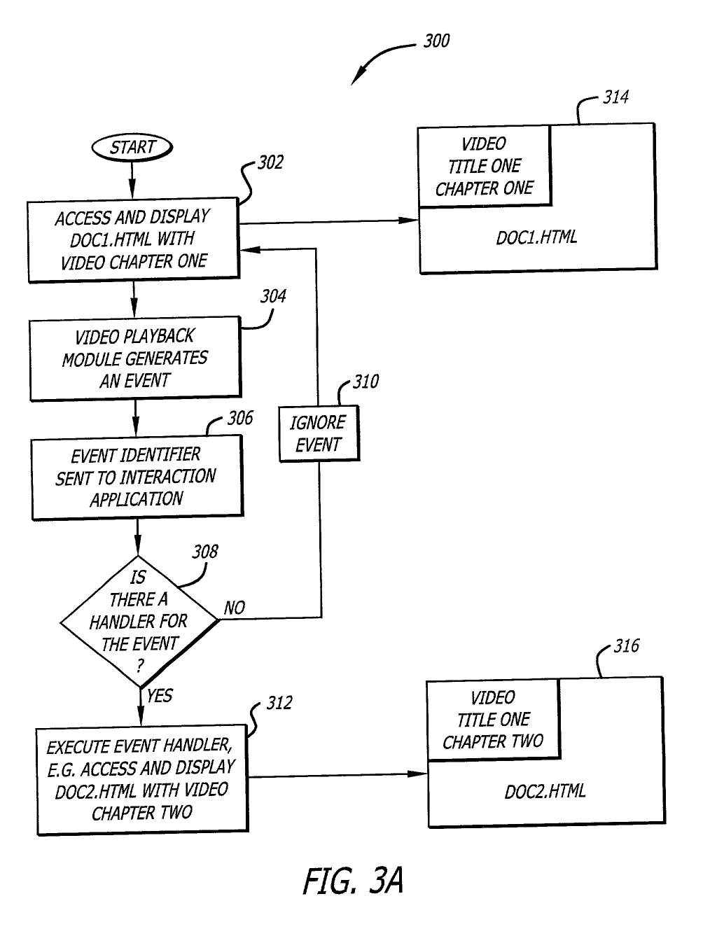

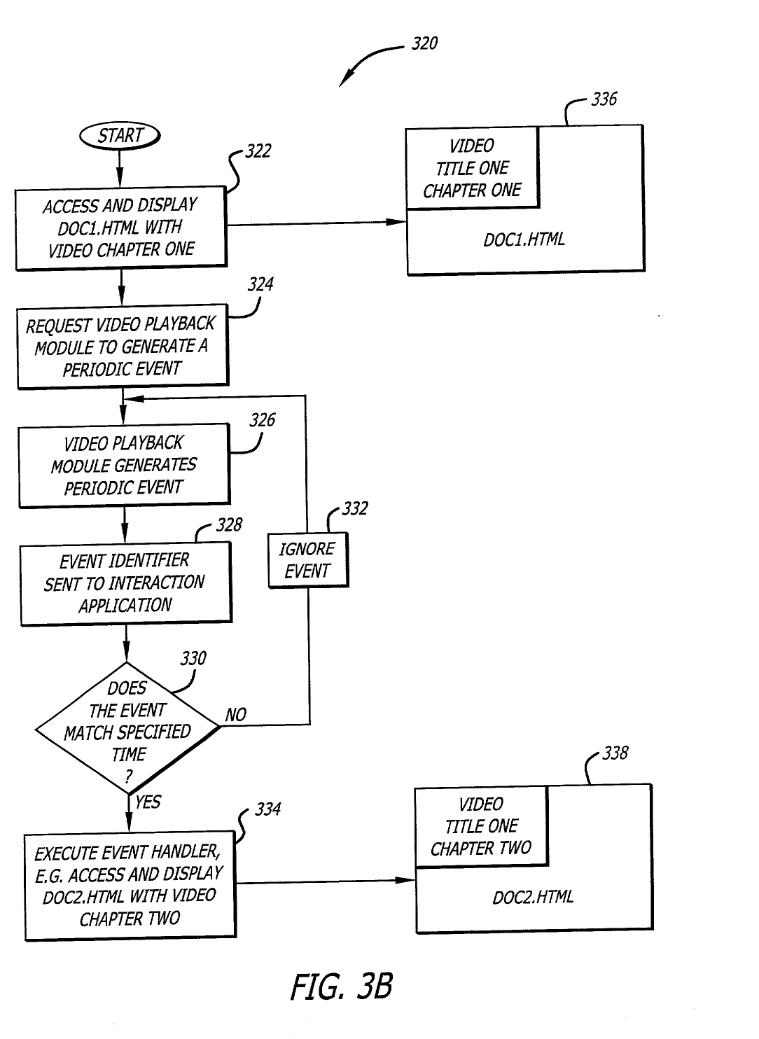

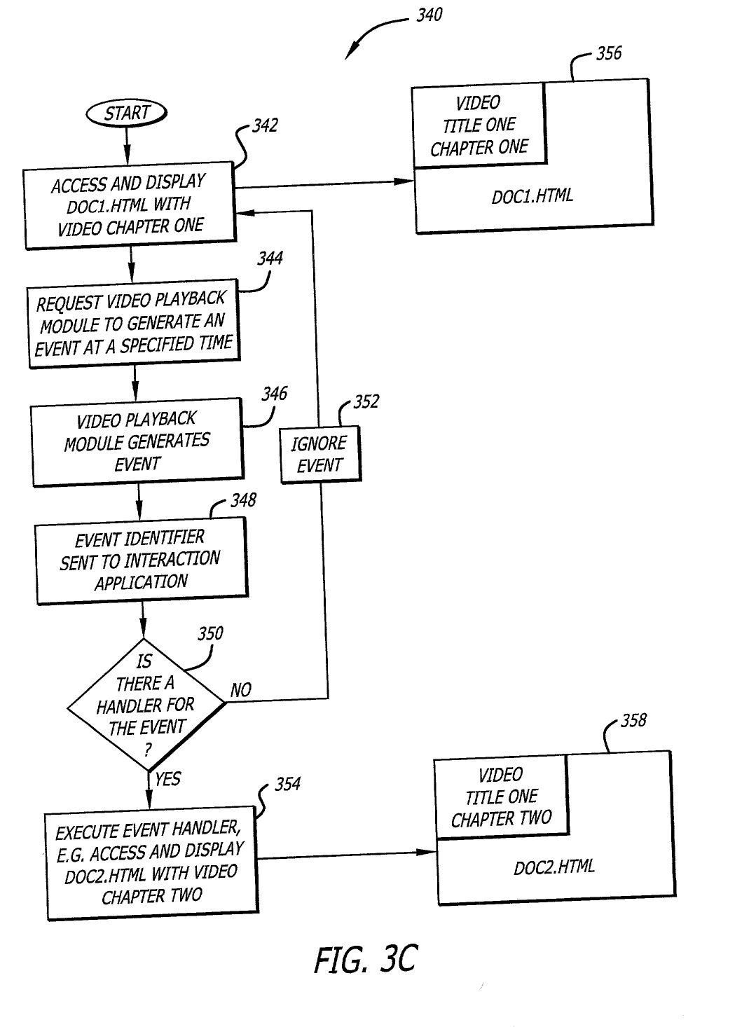

FIG. 3A illustrates a flow diagram of an exemplary method 300 of synchronizing video data with user agent data using an event generated by the video playback module 208 in accordance with the invention. In step 302, the processor 104 under the control of the video playback module 208, user agent module 210, display control module 214, and interaction application 212, accesses and causes the display of user agent document Doc1.HTML 314 with a sub-window displaying video Title one—Chapter one. In step 304, the video playback module 208 generates an event. In this case, an event may be any parameter change related to the playback of the video content. For example, an event can result from the changing of a video title, from the changing of a video chapter, from a specified elapsed of a video playback time, from a user activating a video control button, and/or other parameter change.

In step 306, information relating to the event is passed to the interaction application 212 through the user agent module 210. In step 308, the interaction application 212 receives the event information and makes an inquiry as to whether there is a handler in the interaction application 212 for the event generated. If there is no such handler, in step 310 the event is ignored. If there is a handler, in step 312 the event handling routine in the interaction application 212 is executed which performs a specified action, such as displaying a new user agent document Doc2.HTML 316 with new video segment Title one—Chapter two, or performing some other action.

FIG. 3B illustrates a flow diagram of another exemplary method 320 of synchronizing video data with user agent data using periodic events generated by the video playback module 208 in accordance with the invention. In step 322, the processor 104 under the control of the video playback module 208, user agent module 210, display control module 214, and interaction application 212, accesses and causes the display of user agent document Doc1.HTML 336 with a sub-window displaying video Title one—Chapter one. In step 324, the interaction application 212 through the user agent module 210 requests the video playback module 208 to generate periodic time events. In step 326, the video playback module 208 generates a periodic time event.

In step 328, information relating to the periodic time event is passed to the interaction application 212 through the user agent module 210. In step 330, the interaction application 212 receives the periodic time event information and makes an inquiry as to whether the periodic time event matches a pre-determined time. If no such match is made, in step 332 the periodic time event is ignored. If there is a match, in step 334 the event handling routine in the interaction application 212 is executed which performs a specified action, such as displaying a new user agent document Doc2.HTML 338 with new video segment Title one—Chapter two, or performing some other action.

FIG. 3C illustrates a flow diagram of yet another exemplary method 340 of synchronizing video data with user agent data using a set time event generated by the video playback module 208 in accordance with the invention. In step 342, the processor 104 under the control of the video playback module 208, user agent module 210, display control module 214, and interaction application 212, accesses and causes the display of user agent document Doc1.HTML 356 with a sub-window displaying video Title one—Chapter one. In step 344, the interaction application 212 through the user agent module 210 requests the video playback module 208 to generate a time event at a specified time. In step 346, the video playback module 208 generates the specified time event.

In step 348, information relating to the specified time event is passed to the interaction application 212 through the user agent module 210. In step 350, the interaction application 212 receives the specified time event information and makes an inquiry as to whether there is a handler for the specified time event. If no such handler exist, in step 352 the specified time event is ignored. If there is a handler, in step 354 the event handling routine in the interaction application 212 is executed which performs a specified action, such as displaying a new user agent document Doc2.HTML 358 with new video segment Title one—Chapter two, or performing some other action.

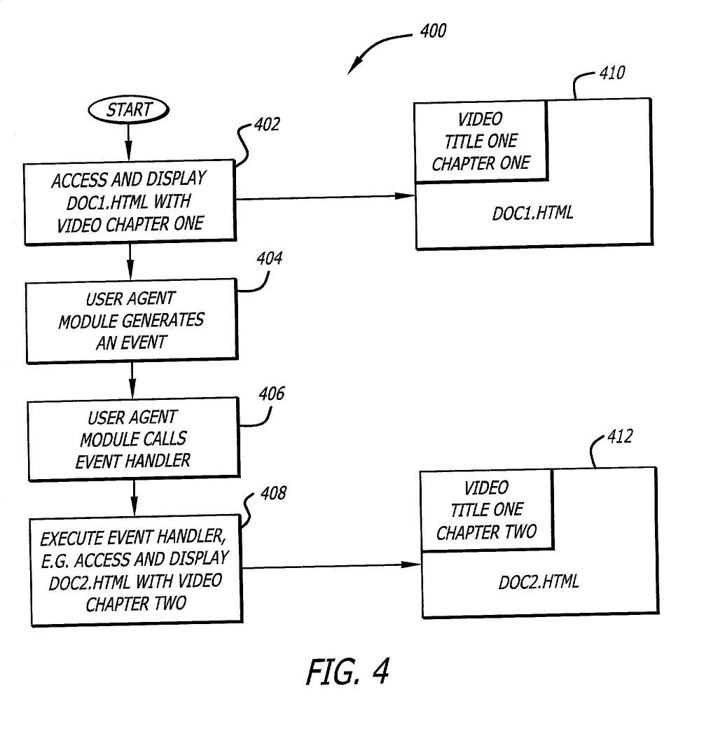

FIG. 4 illustrates a flow diagram of an exemplary method 400 of synchronizing video data with user agent data using an event generated by the user agent module 210 in accordance with the invention. In step 402, the processor 104 under the control of the video playback module 208, user agent module 210, display control module 214, and interaction application 212, accesses and causes the display of user agent document Doc1.HTML 410 with a sub-window displaying video Title one—Chapter one. In step 404, the user agent module 210 or operating system generates an event. In this case, an event can be any parameter change related to the user agent document 410 being displayed. For example, an event can result from a flash routine beginning or ending, from a user activating a link within the user agent document 410, and/or other parameter change. In step 406, the user agent module 210 calls an event handler in the interaction application 212 according to the event that has been generated. The event handler name can be fixed in the user agent module 210 or dynamically changed by the interaction application 212. A fixed event handler can be called for all the generated events to perform the corresponding actions. In step 408, the interaction application 212 executes the event handler which performs a specified action, such as displaying a new user agent document Doc2.HTML 412 with new video segment Title one—Chapter two, or performing some other action.

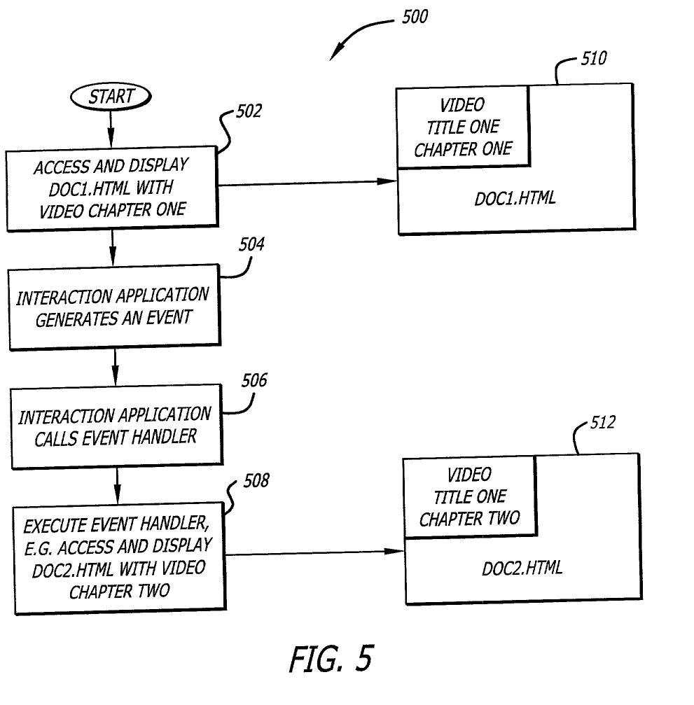

FIG. 5 illustrates a flow diagram of an exemplary method 500 of synchronizing video data with user agent data using an event generated by the interaction application 212 in accordance with the invention. In step 502, the processor 104 under the control of the video playback module 208, user agent module 210, display control module 214, and interaction application 212, accesses and causes the display of user agent document Doc1.HTML 510 with a sub-window displaying video Title one—Chapter one. In step 504, the interaction application 212 generates an event. In this case, an event can be generated by a sub-routine having been executed within the interaction application 212. For example, an event can result from the expiration of a timing routine executed within the interaction application 212, or the calling of a particular sub-routine or function, or the termination of an interrupt sub-routine, or other types of sub-routines occurring within the interaction application 212. In step 506, the interaction application 212 calls an event handler for the event that has been generated. In step 508, the interaction application 212 executes the event handler which performs a specified action, such as displaying a new user agent document Doc2.HTML 512 with new video segment Title one—Chapter two, or performing some other action.

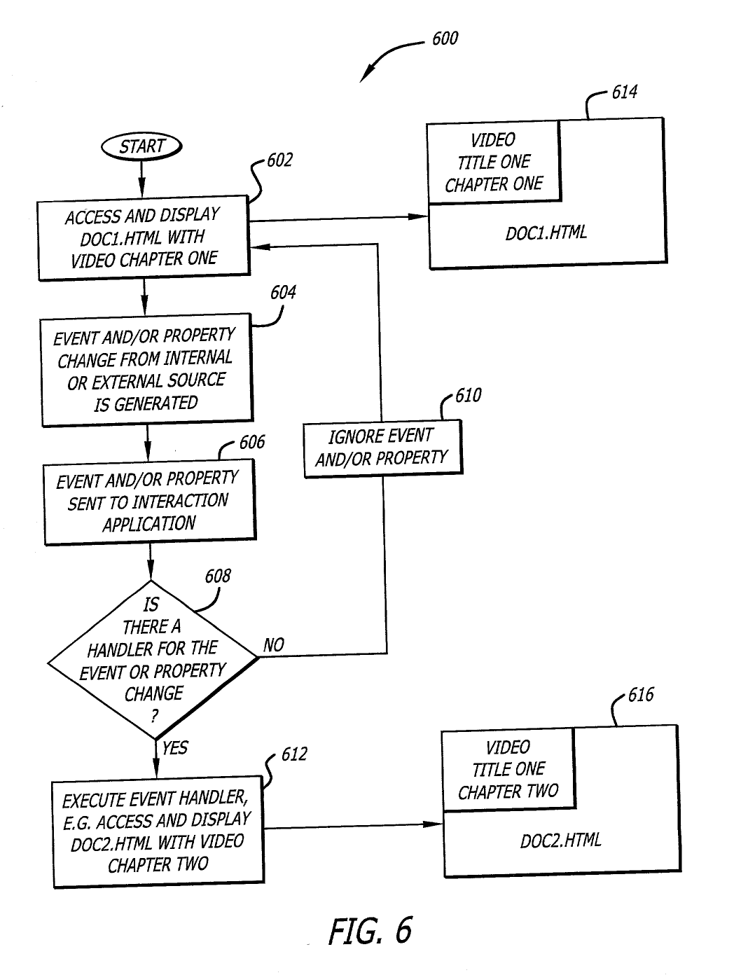

FIG. 6 illustrates a flow diagram of an exemplary method 600 of synchronizing video data with user agent data using an event generated by an internal source (e.g. video playback module, user agent module, interaction application) or by an external source (a server across the Internet or Intranet, an external hard drive, an external optical disc drive) in accordance with the invention. In step 602, the processor 104 under the control of the video playback module 208, user agent module 210, display control module 214, and interaction application 212, accesses and causes the display of user agent document Doc1.HTML 614 with a sub-window displaying video Title one—Chapter one. In step 604, an event is generated by an internal and/or external source. In this case, an event can be generated from a server transmitting information to the optical disc player 100, by an external printer, scanner, digital camera, etc. Or by a property change from an internal or external source, such as the changing of a video title, chapter, the currently displayed user agent document, etc. In step 606, the event (e.g., a property change) information is sent to the interaction application 212. In step 608, the interaction application 212 determines whether there is a handler for the event and/or property change. If there is no handler, in step 610 the event is ignored. If there is a handler, in step 612, the interaction application 212 executes the event handler which performs a specified action, such as displaying a new user agent, document Doc2.HTML 616 with new video segment Title one—Chapter two, or performing some other action.

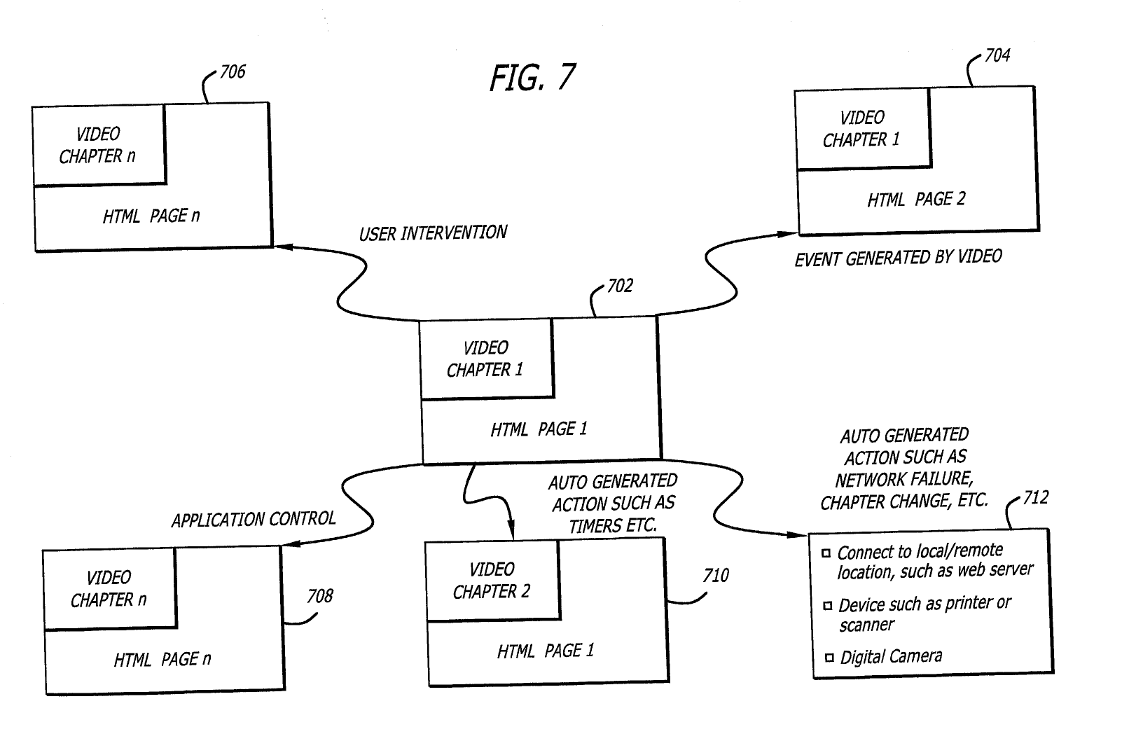

FIG. 7 illustrates a diagram illustrating the results of an exemplary video-user agent data synchronism in accordance the invention. In screen shot 702, an HTML page 1 is shown with video chapter 1. If the video playback system generates an event (e.g. a chapter change, a specified playback time elapse, etc.), the interaction application 212 causes the display of HTML page 2 with video chapter 1 as shown in screen shot 704. If instead the user generates the event (presses a video or HTML control button), the interaction application 212 causes the display of HTML page n with video chapter n as shown in screen shot 706. If instead the application generates an event (e.g. executes a certain routine), the interaction application 212 causes the display of HTML page n with video chapter n as shown in screen shot 708. If instead an event is generated such as by a timer, the interaction application 212 automatically causes the display of HTML page 1 with video chapter 2 as shown in screen shot 710. If instead another type of event such as a network failure or chapter change has occurred, the interaction application 212 causes a connection to a local/remote location, such as a web server, or activates a device such as a printer, scanner or camera as described in box 712.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

In the claims:

1. A method of synchronizing user agent data with video data in an optical disc player, comprising:
displaying a user agent document with a video segment; and
displaying a different user agent document and/or a different video segment in response to an event being generated.

2. The method of claim 1, wherein said event is generated by a video playback module.

3. The method of claim 2, wherein said event relates to a video title being changed.

4. The method of claim 2, wherein said event relates to a video chapter being changed.

5. The method of claim 2, wherein said event relates to a specified time elapsed of video playback occurring.

6. The method of claim 2, wherein said event relates to a user activating a video control function.

7. The method of claim 1, wherein said event is generated by a user agent module.

8. The method of claim 7, wherein said event relates to a content being displayed in the first user agent document.

9. The method of claim 7, wherein said event relates to a user activating a link within said first user agent document.

10. The method of claim 1, wherein said event is generated by an interaction application.

11. The method of claim 10, wherein said event relates to a sub-routine being executed within said interaction application.

12. The method of claim 1, wherein said event is generated from a source external to said optical disc player.

13. The method of claim 1, wherein said event is generated from the operating system in the said optical disc player.

14. The method of claim 12, wherein said source comprises a server on a local area network and/or wide area network.

15. The method of claim 12, wherein said source comprises an external hard disc drive and/or an external optical disc drive.

16. The method of claim 1, wherein said event relates to a parameter being changed.

17. The method of claim 1, further comprising executing an event handler in response to said event which causes said displaying of said different user agent document and/or said different video segment.

18. The method of claim 17, wherein said information related to said event is used to identify said event handler.

19. The method of claim 17, wherein said event handler is identified by a predetermined name.

20. The method of claim 1, wherein said user agent document and/or said different user agent document is accessed from a local optical disc.

21. The method of claim 1, wherein said user agent document and/or said different user agent document is accessed from an external source.

22. The method of claim 1, wherein said video segment and/or said different video segment is accessed from a local optical disc.

23. The method of claim 1, wherein said video segment and/or said different video segment is accessed from an external source.

24. An optical disc player, comprising:
an optical disc reader to read a user agent document, a video segment, a different user agent document, and a second video segment from a local optical disc;
a user agent module to control a display of said user agent document and said different user agent document;
a video playback module to control a display of said video segment and said different video segment; and
an interaction application which causes a display of said user agent document with said video segment, and causes a display of said different user agent document and/or said different video segment in response to an event being generated.

25. The optical disc player of claim 24, wherein said video playback module generates said event.

26. The optical disc player of claim 24, wherein said user agent module generates said event.

27. The optical disc player of claim 24, wherein said interaction application generates said event.

28. The optical disc player of claim 24, further comprising an external source interface, and an indication of said event is received from an external source by way of said interface.

29. The optical disc player of claim 24, further comprising a user input device, and wherein said event derives from said user input device.

30. An optical disc player, comprising:
an optical disc reader to read a user agent document, a video segment, a different user agent document, and a second video segment from a local optical disc; and
a processor to cause a display of said user agent document with said video segment, and to cause a display of said different user agent document and/or said different video segment in response to an event being generated.

31. The optical disc player of claim 30, wherein said processor executes a video playback module which generates said event.

32. The optical disc player of claim 30, wherein said processor executes said user agent module which generates said event.

33. The optical disc player of claim 30, wherein said processor executes an interaction application which generates said event.

34. The optical disc player of claim 30, further comprising an external source interface, and an indication of said event is received from an external source by way of said interface.
